(19) United States
(12) Patent Application Publication
(10) Pub. No.: US 2026/0280855 A1
(43) Pub. Date: Sep. 17, 2026

(54) ACCESS CONTROL SYSTEM, REGISTRATION APPARATUS, REFERENCE APPARATUS, ACCESS CONTROL METHOD, AND COMPUTER READABLE MEDIUM

(71) Applicant: Mitsubishi Electric Corporation, Tokyo (JP)

(72) Inventors: Mitsuhiro MATSUMOTO, Tokyo (JP); Masafumi YAMADA, Tokyo (JP); Kazuki WATANABE, Tokyo (JP)

(73) Assignee: Mitsubishi Electric Corporation, Tokyo (JP)

(21) Appl. No.: 19/667,056

(22) Filed: May 4, 2026

Related U.S. Application Data
(63) Continuation of application No. PCT/JP2023/046730, filed on Dec. 26, 2023.

(51) Int. Cl. H04L 9/08; G06F 21/62; H04L 9/32

(52) U.S. Cl. CPC H04L 9/0833; G06F 21/6209; H04L 9/0825; H04L 9/3236

(57) ABSTRACT

A registration apparatus encrypts a content identifier that identifies content using a group common key for a group that is configured of a plurality of members who are granted access to the content, and registers an encrypted content identifier. A reference apparatus obtains the encrypted content identifier, decrypts the content identifier from the encrypted content identifier using the group common key, and obtains the content using the content identifier.

### CROSS REFERENCE TO RELATED APPLICATION

This application is a Continuation of PCT International Application No. PCT/JP2023/046730, filed on Dec. 26, 2023, which is hereby expressly incorporated by reference into the present application.

### TECHNICAL FIELD

The present disclosure relates to technology for sharing content amongst a plurality of members.

### BACKGROUND ART

Patent Literature 1 discloses technology for concealing content of a file in a short time.

This technology enables concealment of distributed data by encrypting a key information file that is required for restoring divided data.

By this technology, a file can be concealed in a shorter time than encrypting the data.

The technology in Patent Literature 1 involves dividing a file, and managing data by distributing the data by a distributed information system is possible.

On the other hand, an amount of data in a key information file that is targeted for encryption becomes larger in proportion to the number of pieces of data to be divided. Consequently, encryption and decryption processes become slower in proportion to the number of pieces of data to be divided.

The technology in Patent Literature 1 does not take into consideration file sharing by a group (a plurality of people).

### CITATION LIST

### Patent Literature

Patent Literature 1: JP 2019-61574 A

### SUMMARY OF INVENTION

### Technical Problem

The present disclosure aims to make possible high-speed access control to content that is shared among a plurality of members.

### Solution to Problem

An access control system of the present disclosure includes:
a content registration unit to encrypt a content identifier that identifies content using a group common key for a group that is configured of a plurality of members who are granted access to the content, and to register an encrypted content identifier; and
a content obtaining unit to obtain the encrypted content identifier, to decrypt the content identifier from the encrypted content identifier using the group common key, and to obtain the content using the content identifier.

### Advantageous Effects of Invention

According to the present disclosure, high-speed access control to content that is shared among a plurality of members becomes possible.

### BRIEF DESCRIPTION OF DRAWINGS

FIG. 1 is a configuration diagram of an access control system 200 according to Embodiment 1.

FIG. 2 is a configuration diagram of a terminal apparatus 100 according to Embodiment 1.

FIG. 3 is a flow chart of a key management process according to Embodiment 1.

FIG. 4 is a flow chart of a group registration process according to Embodiment 1.

FIG. 5 is a flow chart of a content registration process according to Embodiment 1.

FIG. 6 is a flow chart of a content obtaining process according to Embodiment 1.

FIG. 7 is a diagram illustrating an example of the access control system 200 according to Embodiment 1.

FIG. 8 is a diagram illustrating an example of a blockchain 170 according to Embodiment 1.

FIG. 9 is a diagram illustrating an example of the blockchain 170 according to Embodiment 1.

FIG. 10 is a diagram illustrating an example of a distributed file system 180 according to Embodiment 1.

FIG. 11 is a configuration diagram of a terminal apparatus 100 according to Embodiment 2.

FIG. 12 is a flow chart of a group management process according to Embodiment 2.

FIG. 13 is a flow chart of a content registration process according to Embodiment 2.

FIG. 14 is a flow chart of a content obtaining process according to Embodiment 2.

FIG. 15 is a diagram illustrating an example of an access control system 200 according to Embodiment 2.

FIG. 16 is a diagram illustrating an example of a blockchain 170 according to Embodiment 2.

FIG. 17 is a diagram illustrating an example of a distributed file system 180 according to Embodiment 2.

FIG. 18 is a hardware configuration diagram of a terminal apparatus 100 according to the Embodiments.

### DESCRIPTION OF EMBODIMENTS

In the Embodiments and in the drawings, same reference signs are added to same elements or corresponding elements. Description of elements having the same reference signs added as the elements described will be suitably omitted or simplified. Arrows in the diagrams mainly indicate flows of data or flows of processes.

### Embodiment 1

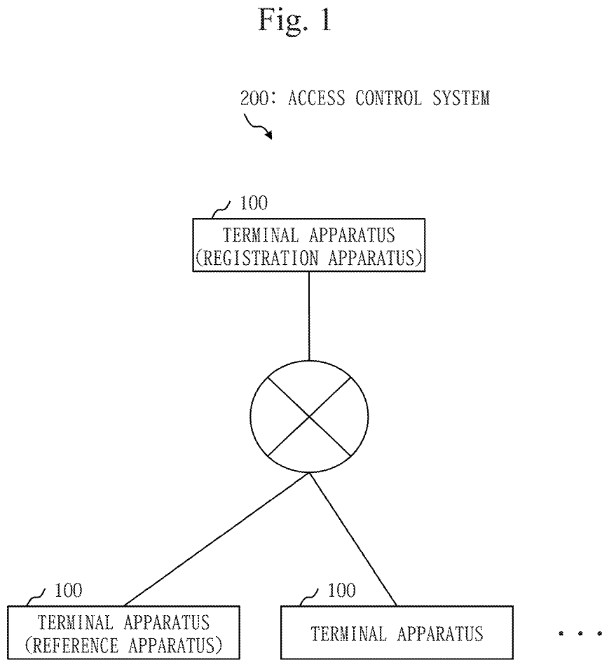

An access control system 200 will be described based on FIG. 1 to FIG. 10.

### Description of Configuration

Based on FIG. 1, a configuration of the access control system 200 will be described.

The access control system 200 includes a plurality of terminal apparatuses 100.

The plurality of apparatuses 100 communicate with each other through a network.

At least one of the terminal apparatuses 100 operates as a registration apparatus.

At least one of the terminal apparatuses 100 operates as a reference apparatus.

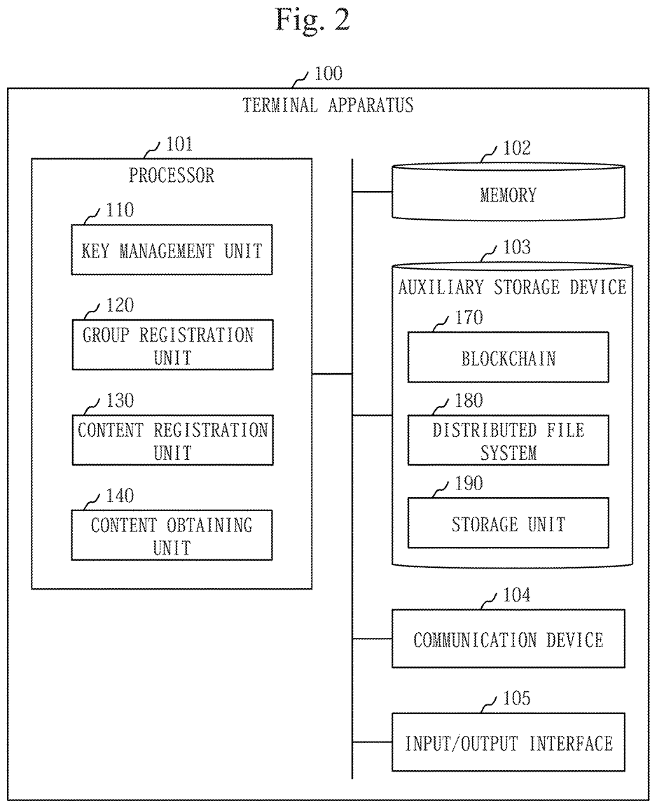

A configuration of a terminal apparatus 100 will be described based on FIG. 2.

The terminal apparatus 100 is a computer that includes hardware such as a processor 101, a memory 102, an auxiliary storage device 103, a communication device 104, and an input/output interface 105. These pieces of hardware are connected with each other through a signal line.

The processor 101 is an IC that performs a calculation process, and controls other pieces of hardware. For example, the processor 101 is a CPU.

IC is an abbreviated name for Integrated Circuit.

CPU is an abbreviated name for Central Processing Unit.

The memory 102 is a volatile or a non-volatile storage device. The memory 102 is also called a main storage device or a main memory. For example, the memory 102 is a RAM. Data stored in the memory 102 is saved in the auxiliary storage device 103 as necessary.

RAM is an abbreviated name for Random Access Memory.

The auxiliary storage device 103 is a non-volatile storage device. The auxiliary storage device 103 is also called storage. For example, the auxiliary storage device 103 is a ROM, an HDD, a flash memory, or a combination of these. The data stored in the auxiliary storage device 103 is loaded into the memory 102 as needed.

ROM is an abbreviated name for Read Only Memory.

HDD is an abbreviated name for Hard Disk Drive.

The communication device 104 is a receiver and a transmitter. For example, the communication device 104 is a communication chip or an NIC. Communication of the terminal apparatus 100 is performed using the communication device 104.

NIC is an abbreviated name for Network Interface Card.

The input/output interface 105 is a port to which an input device and an output device are connected. For example, the input/output interface 105 is a USB terminal, and the input device is a keyboard and a mouse, and the output device is a display. Input and output of the terminal apparatus 100 are performed using the input/output interface 105.

USB is an abbreviated name for Universal Serial Bus.

The terminal apparatus 100 includes at least one element such as a key management unit 110, a group registration unit 120, a content registration unit 130, and a content obtaining unit 140. These elements are realized by software.

The terminal apparatus 100 that operates as the registration apparatus includes at least one of the key management unit 110, the group registration unit 120, and the content registration unit 130.

The terminal apparatus 100 that operates as the reference apparatus includes the key management unit 110 and the content obtaining unit 140.

An access control program for causing a computer to function as the key management unit 110, the group registration unit 120, the content registration unit 130, and the content obtaining unit 140 is stored in the auxiliary storage device 103. The access control program is loaded into the memory 102 and executed by the processor 101.

An OS is further stored in the auxiliary storage device 103. At least a part of the OS is loaded into the memory 102 and executed by the processor 101.

The processor 101, while executing the OS, executes the access control program.

OS is an abbreviated name for Operating System.

Inputted/outputted data of the access control program is stored in a storage unit 190.

The auxiliary storage device 103 functions as the storage unit 190. Storage devices such as the memory 102, a register in the processor 101, a cache memory in the processor 101, and the like, however, may function as the storage unit 190, either in place of the auxiliary storage device 103 or with the auxiliary storage device 103.

The access control program can be computer-readably recorded (stored) in a non-volatile recording medium such as an optical disc, a flash memory, or the like.

The access control program includes a key management program, a registration program, and a reference program.

The key management program causes the computer to function as the key management unit 110.

The registration program causes the computer to function as at least one of the group registration unit 120 and the content registration unit 130.

The reference program causes the computer to function as the content obtaining unit 140.

The auxiliary storage device 103 functions as storage for each of a blockchain 170 and a distributed file system 180.

While the blockchain 170 and the distributed file system 180 are illustrated as being inside the auxiliary storage device 103, the blockchain 170 and the distributed file system 180 utilize functions of each of the processor 101, the memory 102, and the auxiliary storage device 103.

The blockchain 170 of each terminal apparatus 100 configures a network with the blockchain 170 of a different terminal apparatus 100 and manages same data as data of the blockchain 170 of the different terminal apparatus 100.

The distributed file system 180 of each terminal apparatus 100 configures a network with the distributed file system 180 of a different terminal apparatus 100 and manages registered content and content obtained from the different terminal apparatus 100. In the distributed file system 180, for example, each piece of content is managed being fragmented.

### Description of Operation

A procedure of operation of the access control system 200 is equivalent to an access control method. The procedure of the operation of the access control system 200 is equivalent to a procedure of a process by the access control program.

A user identifier is set in advance for each terminal apparatus 100.

The user identifier identifies a user who utilizes the access control system 200. For example, the user identifier identifies an organization that owns the terminal apparatus 100.

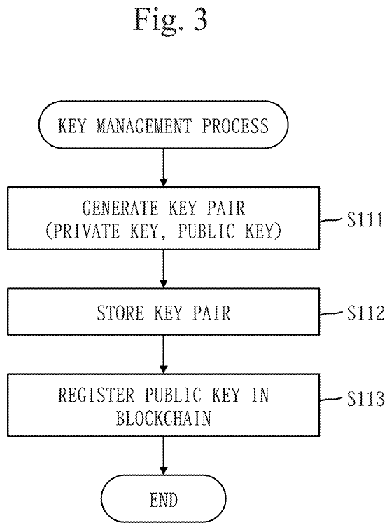

Based on FIG. 3, a key management process of the access control method will be described.

The key management process is executed for each terminal apparatus 100.

In step S111, the key management unit 110 generates a key pair of a public key cryptographic system. As a result, a key pair consisting of a private key and a public key is obtained.

In step S112, the key management unit 110 stores the key pair in the storage unit 190.

In step S113, the key management unit 110 associates the public key with the user identifier and registers the public key in the blockchain 170.

The public key that is registered is shared amongst the plurality of terminal apparatuses 100 through the blockchain 170 of each terminal apparatus 100.

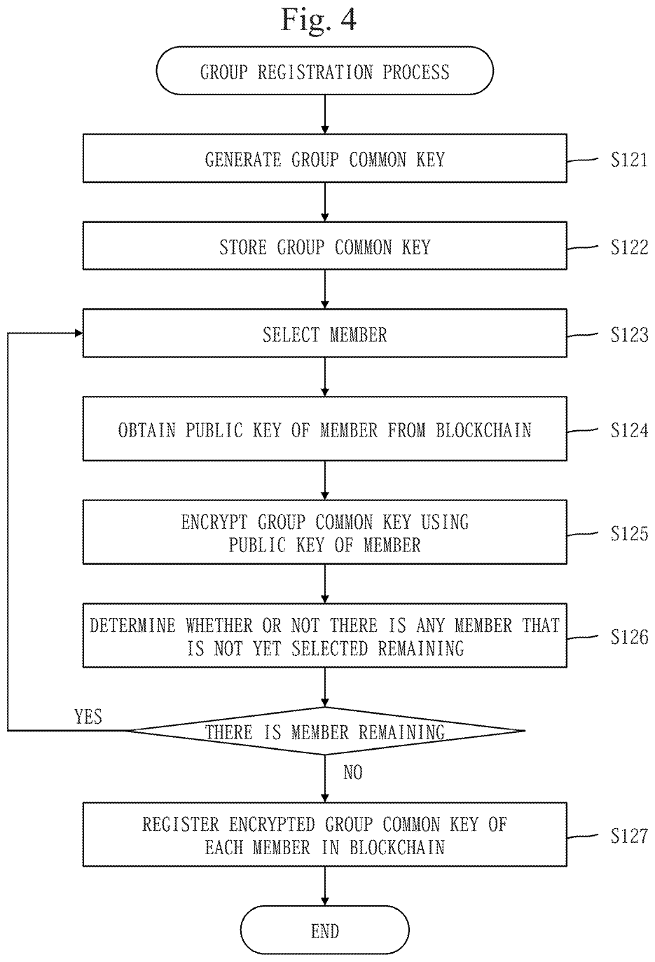

Based on FIG. 4, a group registration process of the access control method will be described.

The group registration process is executed for each terminal apparatus 100 that operates as a (group) registration apparatus.

Registration group information is stored in the memory 102.

The registration group information indicates users (members) that are to be registered to a group among users registered in a blockchain.

The group is configured of a plurality of members who are granted access to specific content.

A member is a user who is registered to and belongs to the group. A user identifier of the user who is the member is called a member identifier.

The registration group information includes a group identifier and one or more member identifiers.

In step S121, the group registration unit 120 generates a key of a common key cryptosystem. As a result, a common key is obtained.

The common key that is obtained is called a group common key.

The group common key is used as a common key for a group that is to be registered.

In step S122, the group registration unit 120 stores the group common key in the storage unit 190.

In step S123, the group registration unit 120 selects from the group that is to be registered, one member that is not yet selected.

Specifically, the group registration unit 120 selects from the registration group information, one member identifier that is not yet selected.

In step S124, the group registration unit 120 obtains from the blockchain 170, a public key of the member that is selected.

Specifically, the group registration unit 120 obtains from the blockchain 170, a public key that is associated with a same user identifier as a member identifier of the member that is selected.

In step S125, the group registration unit 120 encrypts the group common key using the public key of the member that is selected. As a result, an encrypted group common key of the member that is selected is obtained.

In step S126, the group registration unit 120 determines whether or not there is any member that is not yet selected remaining.

In a case where there is any member that is not yet selected remaining, the process proceeds to step S123.

In a case where there is no member that is not yet selected remaining, the process proceeds to step S127.

In step S127, the group registration unit 120 registers in the blockchain 170, the encrypted group common key of each member.

Specifically, the group registration unit 120 registers in the blockchain 170, the member identifier and the encrypted group common key of each member, associating with the group identifier.

The encrypted group common key that is registered is shared among the plurality of terminal apparatuses 100 through the blockchain 170 of each terminal apparatus 100.

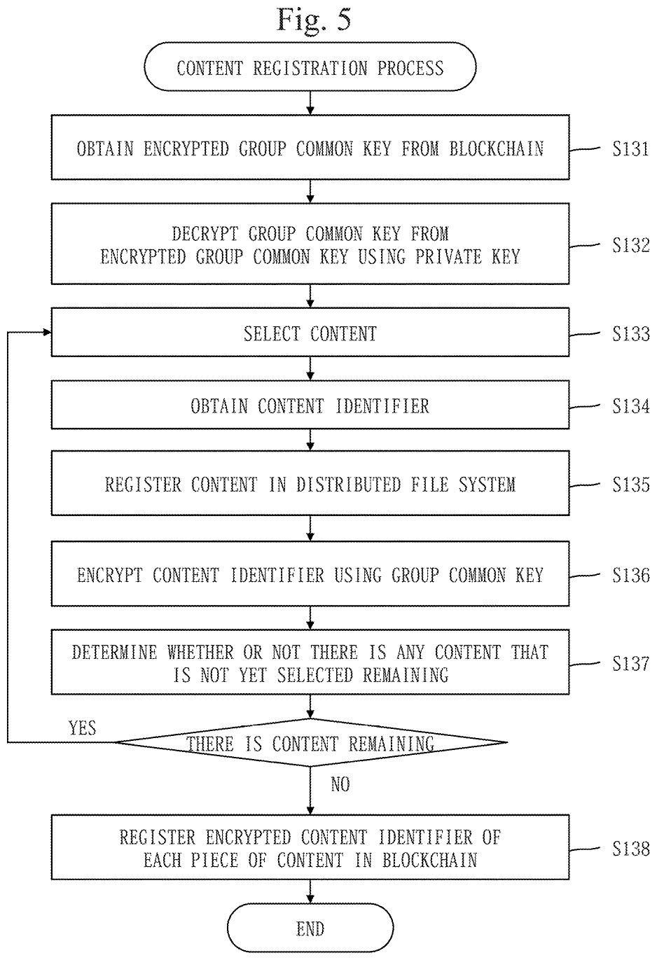

Based on FIG. 5, a content registration process of the access control method will be described.

The content registration process is executed for each terminal apparatus 100 that operates as a (content) registration apparatus.

One or more pieces of content to be registered are designated in advance and stored in the storage unit 190. Information (registration content information) of one or more pieces of content to be registered in the blockchain 170 is stored in the memory 102.

Content is various data that is accessed from a specific group.

The registration content information includes a group identifier and one or more content identifiers.

A member who registers content in a group to which access to the content to be registered is granted, is called a registration member.

In other words, the registration member is a user who uses the terminal apparatus 100 that executes the content registration process.

In step S131, the content registration unit 130 obtains an encrypted group common key of the registration member from the blockchain 170, among a plurality of encrypted group common keys of the group to which access to one or more pieces of content to be registered is granted.

Specifically, the content registration unit 130 obtains from the blockchain 170, an encrypted group common key that is associated with a group identifier that is a same as the group identifier that is included in the registration content information, and that is associated with a member identifier that is a same as a user identifier of the registration member.

In step S132, the content registration unit 130 obtains a private key of the registration member from the storage unit 190.

Then, the content registration unit 130 decrypts the group common key from the encrypted group common key of the registration member using the private key of the registration member.

In step S133, the content registration unit 130 selects from one or more pieces of content to be registered, a piece of content that is not yet selected.

Specifically, the content registration unit 130 selects from the registration content information, one content identifier that is not yet selected.

In step S134, the content registration unit 130 obtains an identifier of the content that is selected.

The content identifier is information that identifies the content.

Specifically, the content registration unit 130 calculates a hash value of the content that is selected. The hash value that is calculated becomes the content identifier.

In step S135, the content registration unit 130 registers in the distributed file system 180, the content that is selected.

Specifically, the content registration unit 130 associates the content that is selected with the content identifier and registers the content in the distributed file system 180.

In step S136, the content registration unit 130 encrypts the content identifier using the group common key. As a result, an encrypted content identifier is obtained.

In step S137, the content registration unit 130 determines whether or not there is any content that is not yet selected remaining.

In a case where there is any content that is not yet selected remaining, the process proceeds to step S133.

In a case where there is no content that is not yet selected remaining, the process proceeds to step S138.

In step S138, the content registration unit 130 registers in the blockchain 170, the encrypted content identifier of each piece of content.

Specifically, the content registration unit 130 associates the content with the group identifier that is a same as the group identifier that is included in the registration content information, and registers in the blockchain 170, the encrypted content identifier, for each piece of content.

The encrypted content identifier that is registered is shared among the plurality of terminal apparatuses 100 through the blockchain 170 of each terminal apparatus 100.

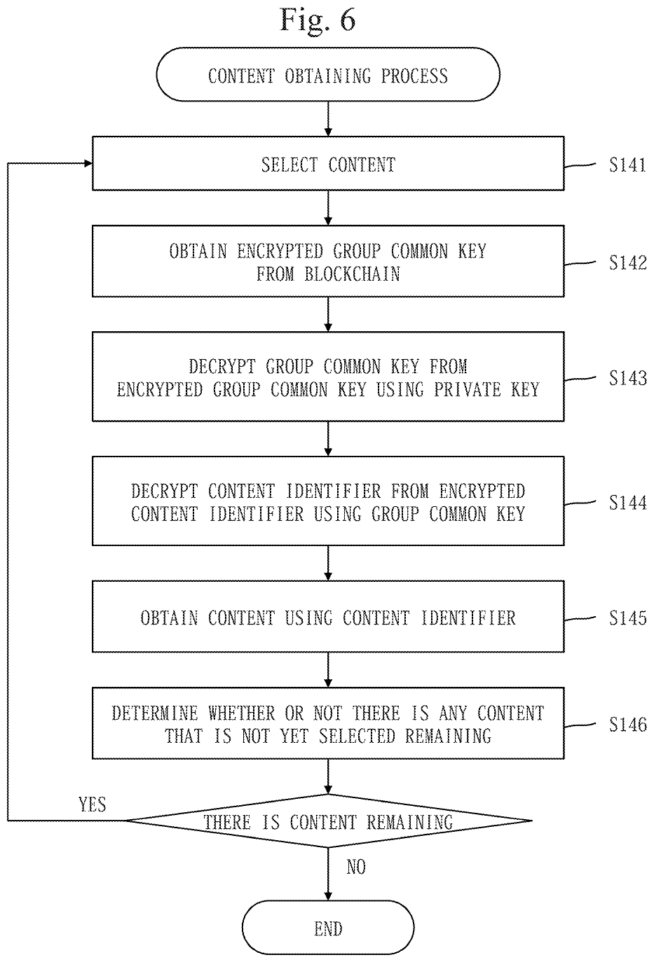

Based on FIG. 6, a content obtaining process of the access control method will be described.

The content obtaining process is executed for each terminal apparatus 100 that operates as the reference apparatus.

A user selects one or more pieces of content to refer to. Then, information (reference content information) of the one or more pieces of content that are selected is stored in the memory 102.

The reference content information includes one or more encrypted content identifiers.

A member who refers to the content is called a reference member.

In other words, the reference member is a user who uses the terminal apparatus 100 that executes the content obtaining process.

In step S141, the content obtaining unit 140 selects a piece of content that is not yet selected from one or more pieces of content to be referred to.

Specifically, the content obtaining unit 140 selects from the reference content information, one encrypted content identifier that is not yet selected.

In step S142, the content obtaining unit 140 obtains from the blockchain 170, an encrypted group common key of the reference member from among a plurality of encrypted group common keys of the group to which access to the content that is selected is granted.

The encrypted group common key is obtained as follows.

First, the content obtaining unit 140 obtains from the blockchain 170, a group identifier that is associated with the encrypted content identifier of the content that is selected.

Then, the content obtaining unit 140 obtains from the blockchain 170, an encrypted group common key that is associated with a group identifier that is a same as the group identifier that is obtained, and that is associated with a member identifier that is a same as a user identifier of the reference member.

In step S143, the content obtaining unit 140 decrypts the group common key from the encrypted group common key of the reference member using a private key of the reference member. The private key of the reference member is obtained from the storage unit 190.

In step S144, the content obtaining unit 140 decrypts the content identifier from the encrypted content identifier using the group common key.

In step S145, the content obtaining unit 140 obtains the content using the content identifier.

Specifically, the content obtaining unit 140 inputs the content identifier to the distributed file system 180 and obtains the content from the distributed file system 180.

The distributed file system 180 outputs content that is associated with the content identifier that is a same as the content identifier that is inputted.

In a case where content that is relevant is not stored, the distributed file system 180 receives the content that is relevant from the distributed file system 180 of a different terminal apparatus 100, and outputs the content that is received. The distributed file system 180 associates the content that is received with the content identifier that is inputted, and stores the content.

In step S146, the content obtaining unit 140 determines whether or not there is any content that is not yet selected remaining.

In a case where there is any content that is not yet selected remaining, the process proceeds to step S141.

In a case where there is no content that is not yet selected remaining, the process ends.

### Description of the Example

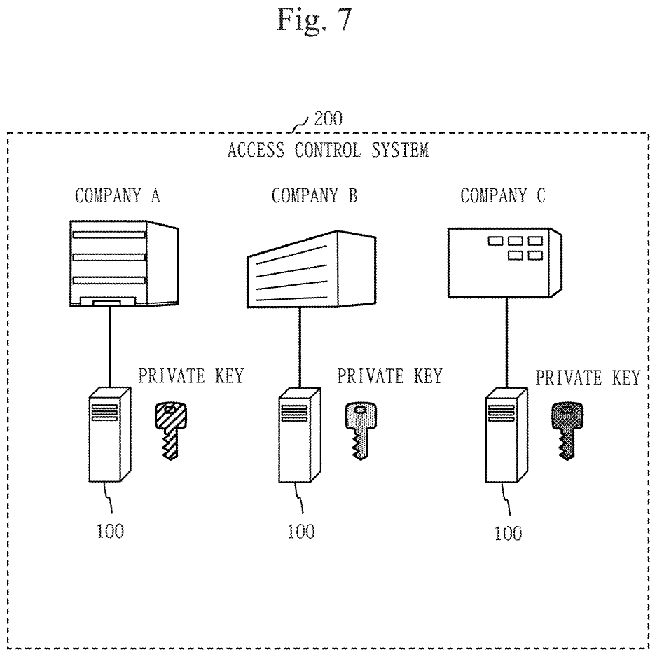

Based on FIG. 7 through FIG. 10, an example of the access control system 200 will be described.

FIG. 7 illustrates a configuration of the access control system 200.

Users of the access control system 200 are Company A, Company B, and Company C.

Each of Company A, Company B, and Company C owns the terminal apparatus 100.

The terminal apparatus 100 of Company A stores a private key of Company A, the terminal apparatus 100 of Company B stores a private key of Company B, and the terminal apparatus 100 of Company C stores a private key of Company C.

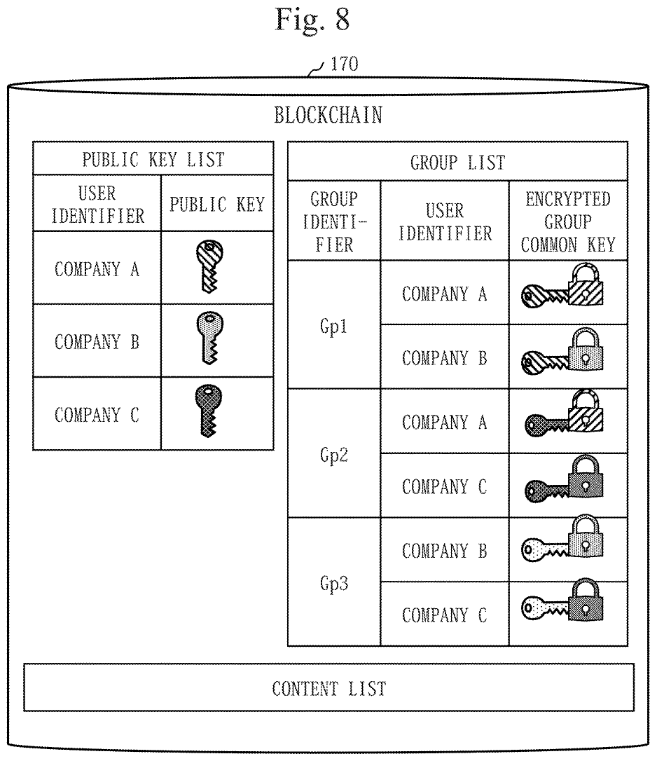

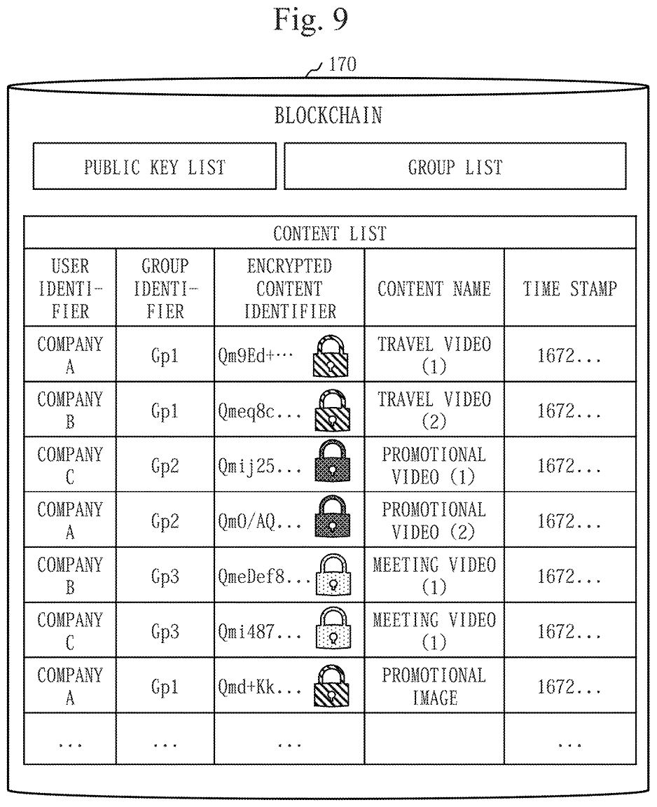

FIG. 8 and FIG. 9 illustrate a configuration of the blockchain 170.

The blockchain 170 has a public key list, a group list, and a content list.

Public keys of each of Company A, Company B, and Company C are registered in the public key list (refer to FIG. 8).

Three groups (Gp1, Gp2, and Gp3) are registered in the group list (refer to FIG. 8).

One or more users belong to each group. For example, Company A and Company B belong to group Gp1.

Specifically, a user identifier and an encrypted group common key of each user (member) being associated with each group name are registered in the group list. The encrypted group common key of each user is obtained by encrypting a group common key using the public key of the user.

For example, in group Gp1, the encrypted group common key of Company A is obtained by encrypting a group common key of group Gp1 using the public key of Company A.

A plurality of encrypted content identifiers are registered in the content list (refer to FIG. 9).

The encrypted content identifier is obtained by encrypting the content identifier (hash value of the content) using a group common key of the group that is granted access to the content.

For example, an encrypted content identifier of group Gp1 is obtained by encrypting the content identifier using the group common key of group Gp1.

Specifically, a registration user identifier, the group identifier, the encrypted content identifier, a content name, and a timestamp are registered for each piece of content in the content list. The registration user identifier indicates a user who registered the content. The timestamp indicates date and time when the content was registered.

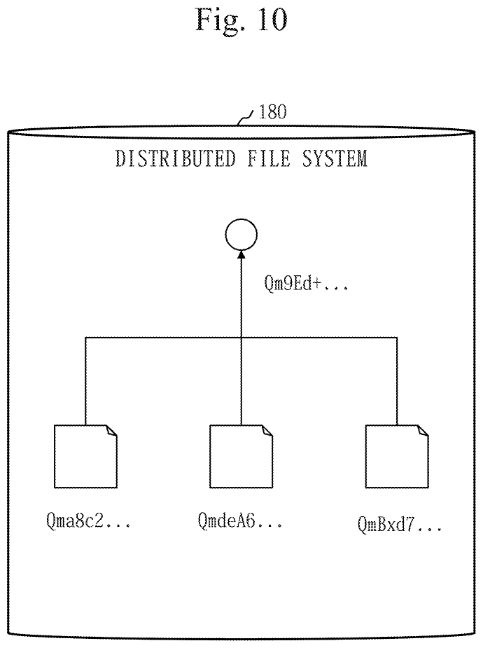

A configuration of the distributed file system 180 is illustrated in FIG. 10.

A plurality of pieces of content are registered in the distributed file system 180.

Each piece of content is managed in the distributed file system 180, and is accessed using the content identifier. In other words, without knowing the content identifier, the content cannot be accessed.

Specifically, in the distributed file system 180, for each piece of content, the content is registered being associated with the content identifier.

The content identifier is obtained by decrypting the encrypted content identifier using the group common key of the group that is granted access to the content.

The group common key is obtained by, for each user, decrypting the encrypted group common key of the user using the private key of the user.

For example, the group common key of group Gp1 is obtained by decrypting the encrypted group common key of Company A of group Gp1 using the private key of Company A. And, a content ID of content of group Gp1 is obtained by decrypting an encrypted content ID of group Gp1 using the group common key of group Gp1.

The distributed file system 180 accepts the content identifier that is inputted and outputs the content that is associated with the content identifier that is a same as the content identifier that is inputted.

For example, in a case where a content identifier (Qm9Ed+ . . . ) is inputted, the distributed file system 180 outputs the content that is associated with the content identifier (Qm9Ed+ . . . ).

### Effects of Embodiment 1

Embodiment 1 can be applied to a distributed information system, achieving higher-speed and resource-saving access control for distributed data.

Specifically, in Embodiment 1, the hash value of the content (about 64 Bytes) is encrypted and decrypted. As a result, compared with a case where the content or a key information file is encrypted and decrypted, a high-speed and resource-saving process is achieved.

Embodiment 1 realizes access control that allows sharing information between groups.

Specifically, in Embodiment 1, to share content within a group, a group common key is encrypted using a public key. A content identifier that serves as an index of the content is encrypted. As a result, each user (registration user) can freely set a disclosure range (group) and share the content. The user (registration user) that registers the content can create the group common key, encrypt the group common key using a public key of each user in the disclosure range, and register the encrypted group common key.

### Embodiment 2

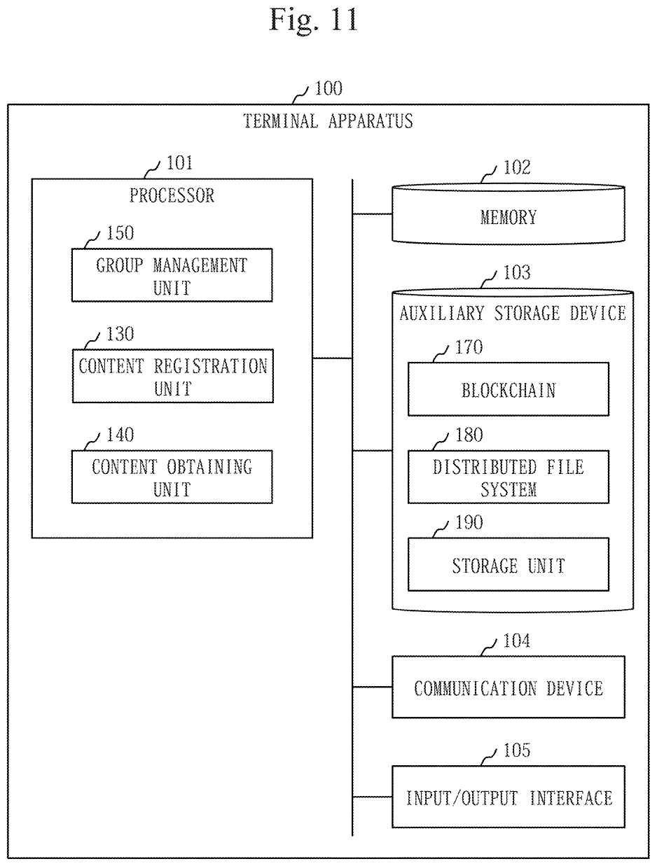

With respect to a form in which the encrypted group common key is not managed by the blockchain, differing points from Embodiment 1 will mainly be described based on FIG. 11 through FIG. 17.

### Description of Configuration

A configuration of the access control system 200 is a same as the configuration in Embodiment 1.

Based on FIG. 11, a configuration of the terminal apparatus 100 will be described.

The terminal apparatus 100 includes elements such as a group management unit 150, the content registration unit 130, and the content obtaining unit 140.

The terminal apparatus 100 that operates as a registration apparatus (or a group management apparatus) includes the group management unit 150.

The terminal apparatus 100 that operates as the registration apparatus includes the content registration unit 130.

The terminal apparatus 100 that operates as the reference apparatus includes the content obtaining unit 140.

The access control program causes a computer to function as the group management unit 150, the content registration unit 130, and the content obtaining unit 140.

### Description of Operation

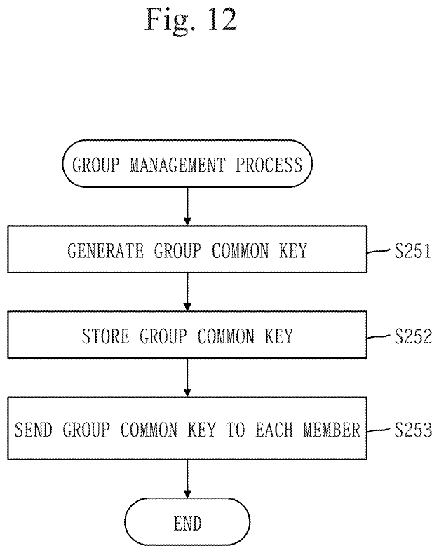

Based on FIG. 12, a group management process of the access control method will be described.

The group management process is executed for each terminal apparatus 100 that operates as the registration apparatus (or the group management apparatus).

Information of a group that is managed (management group information) is designated in advance and stored in the storage unit 190.

The management group information includes a group identifier and one or more pieces of member information.

The member information includes information (for example, an address) for communicating with the terminal apparatus 100 that will be a member.

In step S251, the group management unit 150 generates a key of the common key cryptosystem. As a result, a group common key is obtained.

The process of step S251 is a same as step S121 of Embodiment 1.

In step S252, the group management unit 150 stores the group common key in the storage unit 190.

The process of step S252 is a same as step S122 of Embodiment 1.

In step S253, the group management unit 150 sends the group common key to each member.

Specifically, the group management unit 150 refers to the management group information, associates the group common key with the group identifier, and sends the group common key to each member.

In the terminal apparatus 100 of each member, the group management unit 150 receives the group common key and stores the group common key.

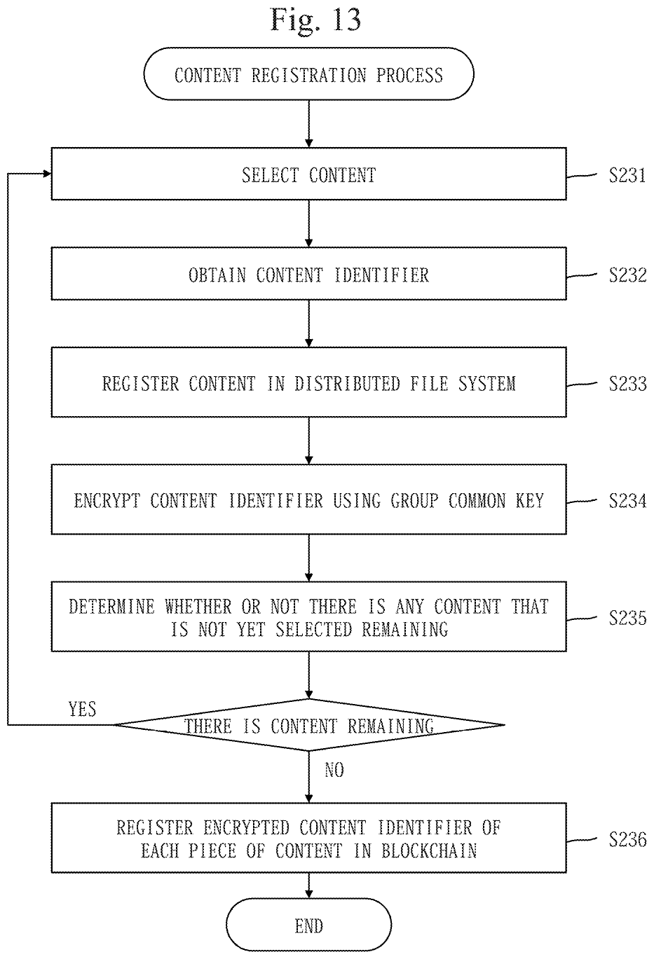

Based on FIG. 13, the content registration process of the access control method will be described.

In step S231, the content registration unit 130 selects a piece of content that is not yet selected from one or more pieces of content to be registered.

Step S231 is a same as step S133 of Embodiment 1.

In step S232, the content registration unit 130 obtains a content identifier of the content that is selected.

Step S232 is a same as step S134 of Embodiment 1.

In step S233, the content registration unit 130 registers the content that is selected in the distributed file system 180.

Step S233 is a same as step S135 of Embodiment 1.

In step S234, the content registration unit 130 encrypts the content identifier using the group common key. As a result, an encrypted content identifier is obtained.

Step S234 is a same as step S136 of Embodiment 1. The group common key, however, is obtained from the storage unit 190.

In step S235, the content registration unit 130 determines whether or not there is any content that is not yet selected remaining.

In a case where there is any content that is not yet selected remaining, the process proceeds to step S231.

In a case where there is no content that is not yet selected remaining, the process proceeds to step S236.

In step S236, the content registration unit 130 registers in the blockchain 170, the encrypted content identifier of each piece of content.

Step S236 is a same as step S138 of Embodiment 1.

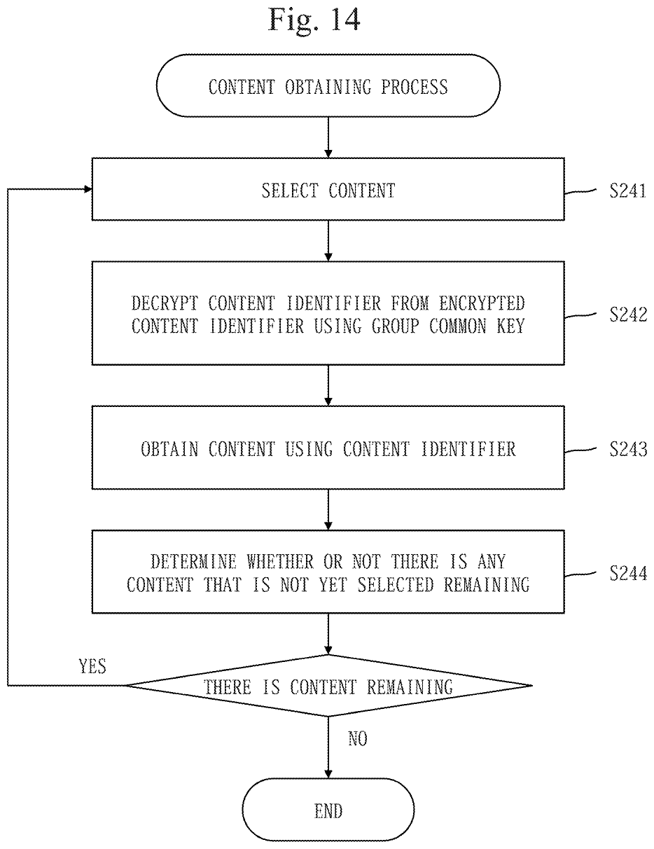

Based on FIG. 14, the content obtaining process of the access control method will be described.

In step S241, the content obtaining unit 140 selects from one or more pieces of content to be referred to, a piece of content that is not yet selected.

Step S241 is a same as step S141 of Embodiment 1.

In step S242, the content obtaining unit 140 decrypts the content identifier from the encrypted content identifier using the group common key.

Step S242 is a same as step S144 of Embodiment 1. The group common key, however, is obtained from the storage unit 190.

In step S243, the content obtaining unit 140 obtains the content using the content identifier.

Step S243 is a same as step S145 of Embodiment 1.

In step S244, the content obtaining unit 140 determines whether or not there is any content that is not yet selected remaining.

In a case where there is any content that is not yet selected remaining, the process proceeds to step S241.

In a case where no content that is not yet selected remaining, the process ends.

### Description of the Example

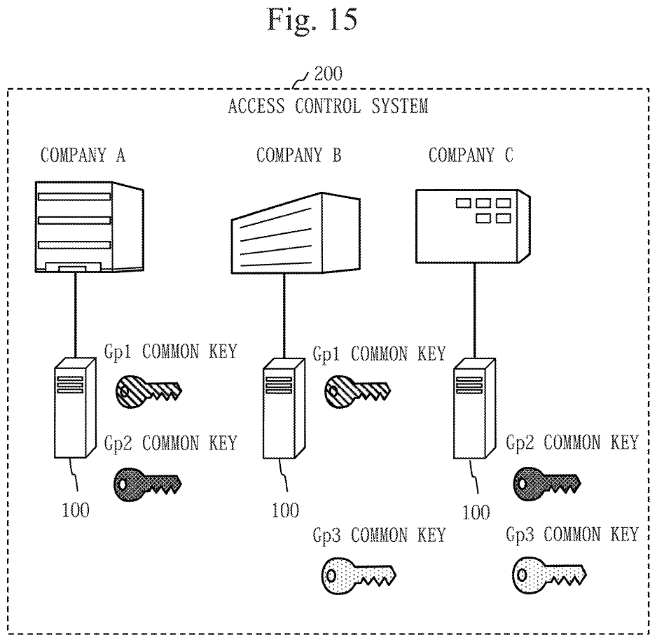

Based on FIG. 15 to FIG. 17, an example of the access control system 200 will be described.

FIG. 15 illustrates a configuration of the access control system 200.

The users of the access control system 200 are Company A, Company B, and Company C.

Each of Company A, Company B, and Company C owns the terminal apparatus 100.

Company A belongs to group Gp1 and group Gp2, and the terminal apparatus 100 of Company A stores the group common key of group Gp1 and a group common key of group Gp2.

Company B belongs to group Gp1 and group Gp3, and the terminal apparatus 100 of Company B stores the group common key of group Gp1 and a group common key of group Gp3.

Company C belongs to group Gp2 and group Gp3, and the terminal apparatus 100 of Company C stores the group common key of group Gp2 and the group common key of group Gp3.

For example, the terminal apparatus 100 of Company A generates and stores the group common key of group Gp1, and sends the group common key of group Gp1 to the terminal apparatus 100 of Company B. The terminal apparatus 100 of Company B then receives and stores the group common key of group Gp1.

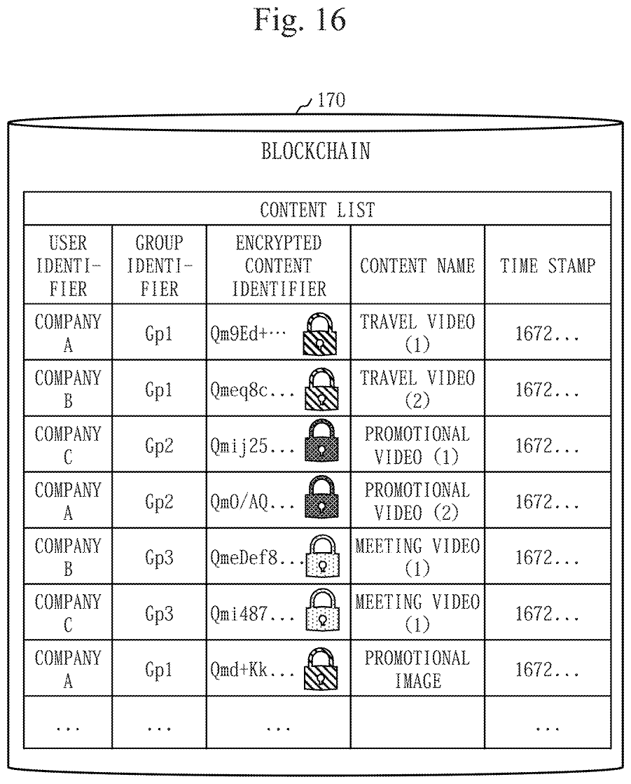

FIG. 16 illustrates a configuration of the blockchain 170.

The blockchain 170 has the content list.

The plurality of encrypted content identifiers are registered in the content list.

Specifically, the registration user identifier, the group identifier, the encrypted content identifier, the content name, and the timestamp for each piece of content are registered in the content list.

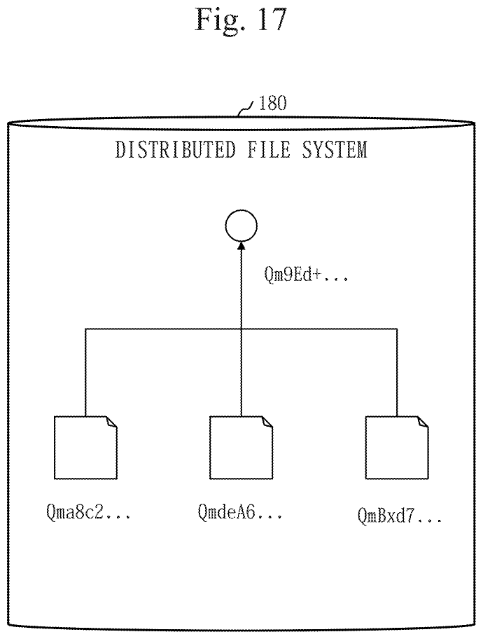

FIG. 17 illustrates a configuration of the distributed file system 180.

The distributed file system 180 manages a piece of content by dividing the content into a plurality of pieces of data.

For example, the content identifier (Qm9Ed+ . . . ) is formed of three pieces of data, content identifiers (Qm8c2 . . . , QmdeA6 . . . , QmBxd7 . . . ).

The plurality of pieces of content are registered in the distributed file system 180.

Specifically, in the distributed file system 180, for each piece of content, the content is registered being associated with the content identifier.

The distributed file system 180 accepts the content identifier that is inputted and outputs the content that is associated with the content identifier that is the same as the content identifier that is inputted.

For example, in a case where the content identifier (Qm9Ed+ . . . ) is inputted, the distributed file system 180 outputs the content that is associated with content identifier (Qm9Ed+ . . . ). In a case where the content that is referred to is the content of group Gp1, the content ID is obtained by decrypting the encrypted content identifier of group Gp1 using the group common key of group Gp1.

### Effects of Embodiment 2

Embodiment 2 can be applied to the distributed information system, achieving higher-speed and resource-saving access control for the distributed data.

Specifically, in Embodiment 2, the hash value of the content (about 64 Bytes) is encrypted and decrypted. As a result, compared with a case where the content or the key information file is encrypted and decrypted, a high-speed and resource-saving process is achieved.

### Supplement to Embodiments

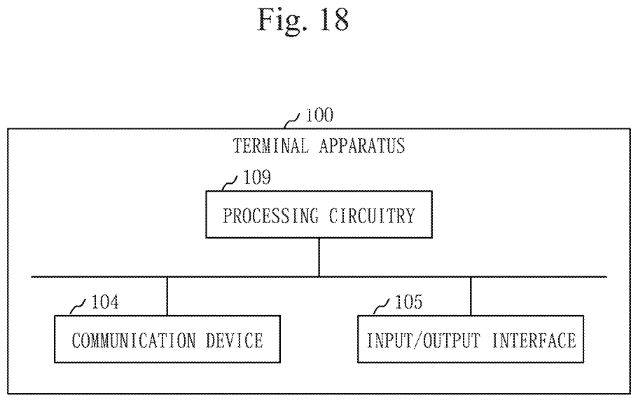

Based on FIG. 18, a hardware configuration of the terminal apparatus 100 will be described.

The terminal apparatus 100 includes processing circuitry 109.

The processing circuitry 109 is hardware that realizes the key management unit 110, the group registration unit 120, the content registration unit 130, the content obtaining unit 140, and the group management unit 150.

The processing circuitry 109 may be dedicated hardware, or may be the processor 101 that executes a program that is stored in the memory 102.

In a case where the processing circuitry 109 is dedicated hardware, the processing circuitry 109, for example, is a single circuit, a composite circuit, a programmed processor, a parallel programmed processor, an ASIC, an FPGA, or a combination of these.

ASIC is an abbreviated name for Application Specific Integrated Circuit.

FPGA is an abbreviated name for Field Programmable Gate Array.

The terminal apparatus 100 may include a plurality of processing circuits as an alternative to the processing circuitry 109.

In the processing circuitry 109, some functions may be realized by dedicated hardware, and the rest of the functions may be realized by software or firmware.

As described, functions of the terminal apparatus 100 can be realized by hardware, software, firmware, or a combination of these.

Each Embodiment is exemplification of a preferred mode, and is not intended to limit the technical scope of the present disclosure. Each embodiment may be carried out partially or may be carried out being combined with a different mode. The procedures described using the flow charts and the like may be changed as appropriate.

“Unit” of each element of the terminal apparatus 100 may be read as “process”, “step”, “circuit”, or “circuitry”.

### REFERENCE SIGNS LIST

100: terminal apparatus; 101: processor; 102: memory; 103: auxiliary storage device; 104: communication device; 105: input/output interface; 109: processing circuitry; 110: key management unit; 120: group registration unit; 130: content registration unit; 140: content obtaining unit; 150: group management unit; 170: blockchain; 180: distributed file system; 190: storage unit; 200: access control system.

1. An access control system comprising:
processing circuitry to execute:
a content registration process to associate content with a content identifier that identifies the content, to register the content without encrypting, to encrypt the content identifier using a group common key for a group that is configured of a plurality of members who are granted access to the content, and to register an encrypted content identifier; and
a content obtaining process to obtain the encrypted content identifier, to decrypt the content identifier from the encrypted content identifier using the group common key, and to obtain the content using the content identifier.

2. The access control system according to claim 1, wherein
the content registration process registers the content in a distributed file system, and
the content obtaining process inputs the content identifier to the distributed file system and obtains the content from the distributed file system.

3. The access control system according to claim 1, wherein
the content registration process encrypts a hash value of the content as the content identifier.

4. The access control system according to claim 1, wherein
the processing circuitry executes
a group registration process to generate the group common key, to encrypt the group common key of each member of the group using a public key of the member, and to register an encrypted group common key of each member of the group,
the content registration process to obtain the encrypted group common key of a registration member who is a member of the group, to decrypt the group common key from the encrypted group common key of the registration member using a private key that corresponds to the public key of the registration member, to encrypt the content identifier using the group common key, and to register the encrypted content identifier, and
the content obtaining process to obtain the encrypted content identifier and the encrypted group common key of a reference member who is a member of the group, to decrypt the group common key from the encrypted group common key of the reference member using a private key that corresponds to the public key of the reference member, to decrypt the content identifier from the encrypted content identifier using the group common key, and to obtain the content using the content identifier.

5. The access control system according to claim 4, wherein
the group registration process registers in a blockchain, the encrypted group common key of each member,
the content registration process registers in the blockchain, the encrypted content identifier, and
the content obtaining process obtains the encrypted content identifier and the encrypted group common key of the reference member from the blockchain.

6. A registration apparatus that is used in the access control system according to claim 4 comprising:
a processing circuitry to execute:
the group registration process.

7. A registration apparatus that is used in the access control system according to claim 1 comprising:
a processing circuitry to execute:
the content registration process.

8. A reference apparatus that is used in the access control system according to claim 1 comprising:
a processing circuitry to execute:
the content obtaining process.

9. An access control method comprising:
associating content with a content identifier that identifies the content, registering the content without encrypting, encrypting the content identifier using a group common key for a group that is configured of a plurality of members who are granted access to the content, and registering an encrypted content identifier, by a registration apparatus; and
obtaining the encrypted content identifier, decrypting the content identifier from the encrypted content identifier using the group common key, and obtaining the content using the content identifier, by a reference apparatus.

10. A non-transitory computer readable medium storing an access control program
for causing a computer that operates as a registration apparatus to execute:
a content registration process to associate content with a content identifier that identifies the content, to register the content without encrypting, to encrypt the content identifier using a group common key for a group that is configured of a plurality of members who are granted access to the content, and to register an encrypted content identifier; and
for causing a computer that operates as a reference apparatus to execute:
a content obtaining process to obtain the encrypted content identifier, to decrypt the content identifier from the encrypted content identifier using the group common key, and to obtain the content using the content identifier.
